(19) United States
(12) Patent Application Publication
(10) Pub. No.: US 2026/0169136 A1
(43) Pub. Date: Jun. 18, 2026

(54) DISTANCE MEASUREMENT SYSTEM

(71) Applicant: Panasonic Intellectual Property Management Co., Ltd., Osaka (JP)

(72) Inventors: Akito INOUE, OSAKA FU (JP); Taiki KUNIKYO, OSAKA FU (JP)

(21) Appl. No.: 18/851,188

(22) PCT Filed: Mar. 22, 2023
(86) PCT No.: PCT/JP2023/011141

§ 371 Date: Sep. 26, 2024

(30) Foreign Application Priority Data
Mar. 28, 2022 (JP) 2022-051661

(51) Int. Cl. G01S 7/4865; G01S 7/481; G01S 7/484; G01S 17/10

(52) U.S. Cl. CPC G01S 7/4865; G01S 7/4816; G01S 7/484; G01S 17/10

(57) ABSTRACT

A distance measurement system used in an environment where background light is present includes: a light emitter configured to emit pulsed light; a light receiver configured to receive reflected light reflected by a target object; a controller configured to control operation of the light emitter and the light receiver; and a distance calculator configured to calculate a distance to the target object. The controller changes a product of an intensity, a pulse width, and a pulse count of the pulsed light according to a power function where a distance to be measured is a variable, such that a power exponent of the power function is set greater than 3 and less than or equal to 4.

### TECHNICAL FIELD

The present disclosure relates to a distance measurement system used in an environment where background light is present.

### BACKGROUND ART

Patent Document 1 discloses a distance measurement device adopting a Time Of Flight (TOF) method, where a technique for changing a pulsed light emission condition depending on a distance according to an S/N ratio is used.

### CITATION LIST

### Patent Document

Patent Document 1: Japanese Unexamined Patent Publication No. 2010-156711

### SUMMARY OF THE INVENTION

### Technical Problem

However, Patent Document 1 fails to disclose any guidelines for how setting of light intensity should be changed when a light source with a low light intensity such as a diffusion light source is used, for example, under background light such as daylight.

In view of the foregoing, it is an object of the present disclosure to provide a distance measurement system used in an environment where background light is present and being capable of appropriate setting of light intensity of pulsed light to be emitted.

### Solution to the Problem

A distance measurement system used in an environment where background light is present according to one aspect of the present disclosure includes: a light emitter configured to emit pulsed light; a light receiver configured to receive the pulsed light reflected by a target object; a controller configured to control operation of the light emitter and the light receiver; and a distance calculator configured to calculate a distance to the target object based on a time taken before the pulsed light returns to the light receiver, wherein the controller changes a product of an intensity, a pulse width, and a pulse count of the pulsed light according to a power function where a distance to be measured is a variable, such that a power exponent of the power function is set to a first value greater than 3 and less than or equal to 4.

### Advantages of the Invention

According to the present disclosure, efficient setting of light intensity of pulsed light in an environment where background light is present can be made for a target distance, and thus a range of distance to be measured can be broader.

### BRIEF DESCRIPTION OF THE DRAWINGS

FIG. 1 is a schematic diagram of a configuration of a distance measurement system according to an embodiment.

FIG. 2 shows an exemplary distance measurement sequence.

FIGS. 3A to 3C show exemplary simulation results.

FIG. 4 shows a simulation result where the required pulse count was calculated for each distance.

FIG. 5 shows simulation results where the power exponents were calculated.

FIG. 6 shows a modification of the distance measurement sequence.

FIG. 7 shows an exemplary circuit configuration of a photodetector used for a light receiver.

FIG. 8 shows an exemplary circuit configuration of a photodetector used for a light receiver.

FIG. 9 is a timing chart of operation of the photodetector of FIG. 8.

FIG. 10 is a sectional view of an exemplary device configuration of the photodetector of FIG. 8.

FIG. 11 shows an exemplary set of timings of light emission, light reflection, and light exposure according to a sub-range method.

FIG. 12 shows an exemplary simulation of signal intensity in each distance section shown in FIG. 11.

FIG. 13 shows an exemplary distance measurement sequence according to the sub-range method.

FIG. 14 shows an exemplary algorithm for determining presence or absence of a subject and a distance to the subject in a determination period.

FIG. 15 shows an exemplary circuit configuration of a photodetector used for a light receiver.

FIG. 16 shows exemplary signal changes in a time measurement operation of the circuit of FIG. 15.

FIG. 17 shows an example of histogram processing where the operation of FIG. 16 is conducted several times.

### DESCRIPTION OF EMBODIMENTS

### Overview

A distance measurement system used in an environment where background light is present according to one aspect of the present disclosure includes: a light emitter configured to emit pulsed light; a light receiver configured to receive the pulsed light reflected by a target object; a controller configured to control operation of the light emitter and the light receiver; and a distance calculator configured to calculate a distance to the target object based on a time taken before the pulsed light returns to the light receiver, wherein the controller changes a product of an intensity, a pulse width, and a pulse count of the pulsed light according to a power function where a distance to be measured is a variable, such that a power exponent of the power function is set to a first value greater than 3 and less than or equal to 4.

According to this configuration, efficient setting of light intensity of pulsed light can be made according to a distance to be measured, and thus a range of distance to be measured can be broader.

The distance measurement system of the above aspect may have a function of detecting an intensity of background light, and the controller may set the power exponent of the power function to a value greater than 2 and less than or equal to the first value if the intensity of the background light detected falls below a predetermined reference.

Accordingly, efficient setting of light intensity of pulsed light can be made even in an environment where background light is weak.

In the distance measurement system of the above aspect, the light receiver may include a plurality of photodetectors arranged in an array, and the light emitter may emit diffused light as the pulsed light.

Further, the photodetector may include a photon counter or a single photon avalanche diode (SPAD).

Further, each of the photodetectors may include a first memory provided inside the photodetector and configured to record a light detection count, and the light receiver may include a second memory provided outside the photodetector and configured to record a light detection count.

Further, when the background light is measured, the second memory may be used if the intensity of the background light is high, and the first memory may be used if the intensity of the background light is low.

Further, the first memory may be a metal-insulator-metal capacitor (MIM).

Further, the photodetector may include a photodiode, a reset transistor, a floating diffusion, a transfer transistor, and a count transistor.

Further, the distance measurement system of the above aspect may divide an imaging region into a plurality of sections based on distances; generate a section image for each of the plurality of sections; and generate a distance image based on the plurality of section images.

An embodiment will be described in detail with reference to the drawings.

The embodiment described below shows a general or specific example. The numerical values, shapes, materials, components, the arrangement and connection of the components, steps, step orders etc. shown in the following embodiment are thus mere examples, and are not intended to limit the scope of the present disclosure. Among the components described in the following embodiment, those not recited in the independent claims which embody the broadest concept of the present disclosure will be described as optional.

### EMBODIMENTS

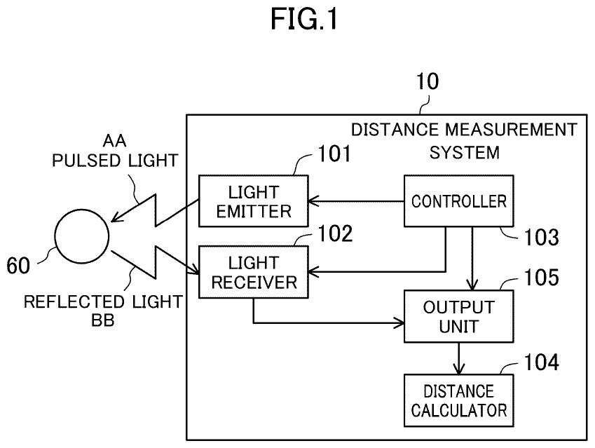

FIG. 1 is a schematic diagram of a configuration of a distance measurement system according to an embodiment. A distance measurement system 10 includes: a light emitter 101 configured to emit pulsed light AA toward a measurement target 60; a light receiver 102 configured to receive reflected light BB reflected on the measurement target 60; a controller 103 configured to control operation of the light emitter 101 and the light receiver 102; a distance calculator 105 configured to calculate a distance to the measurement target 60 upon reception of a signal corresponding to the reflected light BB from the light receiver 102; and an output unit 104 configured to output the distance calculated by the distance calculator 105. The distance calculator 105 calculates the distance to the measurement target 60 based on the time taken before the pulsed light AA returns to the light receiver 102.

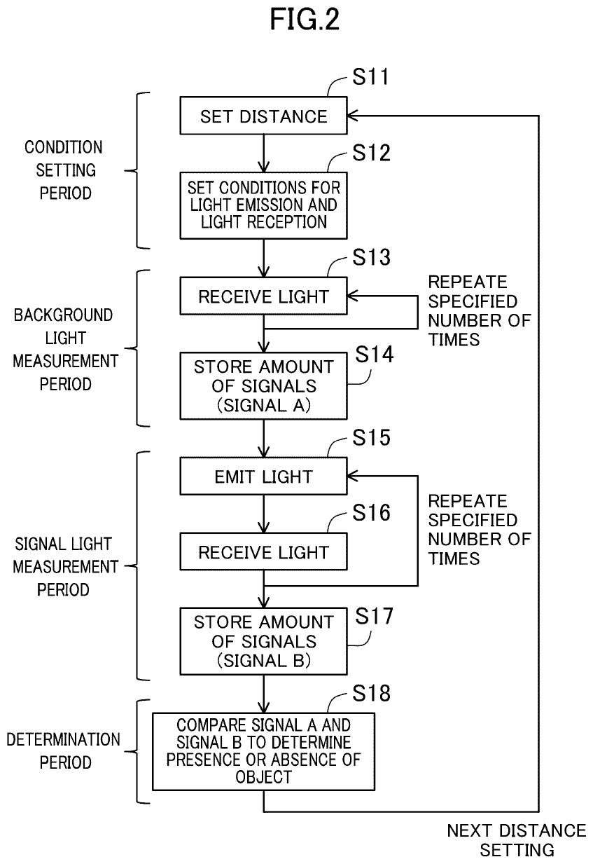

FIG. 2 shows an exemplary distance measurement sequence. The sequence of FIG. 2 includes a condition setting period, a background light measurement period, a signal light measurement period, and a determination period.

In the condition setting period, the controller 103 sets a distance or distance range to be measured (S11) and sets conditions for light emission and light reception (S12). The conditions for light emission include the width, intensity, and count of the light pulse emitted, and the timing of emission. The condition for light reception includes a timing of exposure and a duration of exposure.

In the background light measurement period, the light receiver 102 receives light according to the conditions set in the condition setting period (S13). At this time, the light emitter 101 does not emit light. This light receiving operation is repeated a specified number of times. The light receiver 102 transmits the amount of signals obtained by light reception to the distance calculator 105, and the distance calculator 105 stores the amount of signals as a signal A that is the amount of signals generated by the background light (S14).

In the signal light measurement period, the light emitter 101 emits light (S15) and the light receiver 102 receives light (S16) according to the conditions set in the condition setting period. This operation of light emission and light reception is repeated a specified number of times. The light receiver 102 transmits the amount of signals obtained by light reception to the distance calculator 105, and the distance calculator 105 stores the amount of signals as a signal B (S17).

In the determination period, the distance calculator 105 compares the signal A and the signal B to determine presence or absence of an object. If a significant difference is found between the signal B and the signal A, it is determined that an object is present within the specified distance range (S18). After the determination period, the process returns to the condition setting period, and the same sequence is repeated.

Here, the background light measurement period may not necessarily be set in all sequences. In a period in which the background light does not change, a measurement result of a single background light measurement period in a plurality of sequences may be used for a determination period. In FIG. 2, in the signal light measurement period, light reception is done after light emission is done, but light emission and light reception may be done at the same timing.

### <Setting of Light Emission Conditions>

The present embodiment is characterized in setting of the light emission conditions. Here, under the condition that the background light has a high intensity, the product of the light pulse width, the light pulse intensity, and the light pulse count is desirably larger as the distance and its range are set farther and broader, respectively. In this specification, the product of the light pulse width, the light pulse intensity, and the light pulse count is referred to as total light intensity as necessary. In particular, the total light intensity of light emitted is changed according to a power function where the distance to be measured is a variable, and a power exponent of that power function is desirably a value greater than 3 and less than or equal to 4. The reason will be described below.

The probability that the intensity of light detected by the light receiver 102 in one single light reception is one photon or less and that k photons are detected by the light receiver 102 in n times of light receptions follows the binomial distribution below.

$$[ Expression 1 ]$$

$$P ( n , k ) = {}_{n} {C}_{k} p ( 1 - p ) \qquad ( 1 )$$

nCₖ: Binomial Coefficient, p: Average Number of Photons Detected in One Light Reception

In this case, the mean μ and the standard deviation σ of the binomial distribution P(n, k) can be written as follows.

$$[ Expression 2 ]$$

$$μ = np \qquad ( 2 )$$

$$σ = \sqrt{np ( 1 - p )} \qquad ( 3 )$$

Here, p, μ, and σ, where the light emitter 101 does not emit light and where light incident on the light receiver 102 is the background light alone, are p_{BG}, μ_{BG}, and σ_{BG}, respectively; p, μ, and σ of light which is emitted by the light emitter 101, is reflected by the target object, and returns to the light receiver 102 are p_{sig}, μ_{sig}, and σ_{sig}, respectively; and p, μ, and σ of the sum of the light which is emitted by the light emitter 101, is reflected by the target object, and returns to the light receiver 102, and the background light are p_{sig+BG}, μ_{sig+BG}, and σ_{sig+BG}, respectively. In this case, the following relational expressions are obtained.

$$[ Expression 3 ]$$

$${p}_{sig + BG} = {p}_{sig} + {p}_{BG} \qquad ( 4 )$$

$${μ}_{sig + BG} = {μ}_{sig} + {μ}_{BG} \qquad ( 5 )$$

$${σ}_{sig + BG} = \sqrt{{np}_{sig + BG} ( 1 - {p}_{sig + BG} )} \qquad ( 6 )$$

The condition for separating the signal light and the background light can be set as the following expression.

$$[ Expression 4 ]$$

$${μ}_{sig + BG} - {σ}_{sig + BG} \geq {μ}_{BG} + {σ}_{BG} \qquad ( 7 )$$

When pulsed light is emitted, reflected by a target object, and incident on the light receiver 102, the intensity of the pulsed light attenuates in inverse proportion to the square of the distance L to the target object. Accordingly, the following relational expression is obtained.

$$[ Expression 5 ]$$

$${p}_{sig} ∝ {L}^{- 2} \qquad ( 8 )$$

Meanwhile, the intensity of the background light is constant irrespective of the distance L. Accordingly, the following relational expression is obtained.

$$[ Expression 6 ]$$

$${p}_{BG} ∝ {L}^{0} = 1 \qquad ( 9 )$$

Here, the expression (7) representing the condition for separating the signal light from the background light is rewritten as follows by using the expression (5).

$$[ Expression 7 ]$$

$${μ}_{sig} \geq {σ}_{sig + BG} + {σ}_{BG} \qquad ( 10 )$$

Here, if the returning signal light is weaker than the background light, the following expression is obtained.

$${σ}_{sig + BG} ≃ {σ}_{BG} \qquad [ Expression 8 ]$$

$$∵ {p}_{sig} << {p}_{BG}$$

Then, the expression (10) is further rewritten as follows.

$$[ Expression 9 ]$$

$${μ}_{sig} \geq 2 {σ}_{BG} \qquad ( 11 )$$

Here, if the equality of the expression (11) holds true and the threshold of the light reception count n is Nth, the following expression is obtained from the expressions (2) and (3).

$$[ Expression 10 ]$$

$${N}_{th} {p}_{sig} = 2 \sqrt{{N}_{th} {p}_{BG} ( 1 - {p}_{BG} )} \qquad ( 12 )$$

Then, squaring both sides of this expression leads to the following.

$$[ Expression 11 ]$$

$${( {N}_{th} {p}_{sig} )}^{2} = 4 {N}_{th} {p}_{BG} ( 1 - {p}_{BG} ) \qquad ( 13 )$$

$${N}_{th} = \frac{4 {p}_{BG} ( 1 - {p}_{BG} )}{{p}_{sig}^{2}} ∝ {L}^{4} \qquad ( 14 )$$

That is, the threshold Nth of the light reception count n varies in proportion to the distance L raised to the power of 4. Thus, when the distance is measured while being changed, the pulse count is desirably increased in proportion to the distance raised to the power of 4.

The above analysis assumes that the light pulse width and the light pulse intensity are constant. However, the light pulse width and the light pulse intensity may be variable. That is, the total light intensity of light emitted, i.e., the product of the light pulse width, the light pulse intensity, and the light pulse count is desirably increased in proportion to the distance raised to the power of 4.

Note that the power exponent is 4 when the intensity of signal light is extremely weaker than the intensity of the background light. As will be described later, the power exponent for change in the pulse count with respect to the distance may be smaller than 4, and does not fall below 3 under practical experiment conditions. Thus, the power exponent is desirably greater than 3 and less than or equal to 4.

The above analysis uses the expression (7) as a condition for separating the background light and the signal light, but the standard deviation σ may be multiplied by a constant according to a required accuracy. Specifically, the following expression may be used with a constant k.

$$[ Expression 12 ]$$

$${μ}_{sig + BG} - k {σ}_{sig + BG} \geq {μ}_{BG} + k {σ}_{BG} \qquad ( {7}^{′} )$$

In this case, as the K is larger, the accuracy is higher, and as the K is smaller, the accuracy is lower. In this case too, the power exponent is desirably greater than 3 and less than or equal to 4.

Accordingly, the present embodiment is effective in detecting the signal light having relatively weak intensity when the background light has high intensity. An exemplary situation where the present embodiment is effective is that the signal light is emitted by a light diffusion source in the environment where the background light is sunlight. Here, the light diffusion source refers to a light source that diffuses light to the field viewed from the light receiver 102. Within the field viewed from the light receiver 102, the intensity of diffused light may be even or uneven. Some distance measurement systems using a light diffusion source are referred to as Flash LiDAR.

### <Simulation>

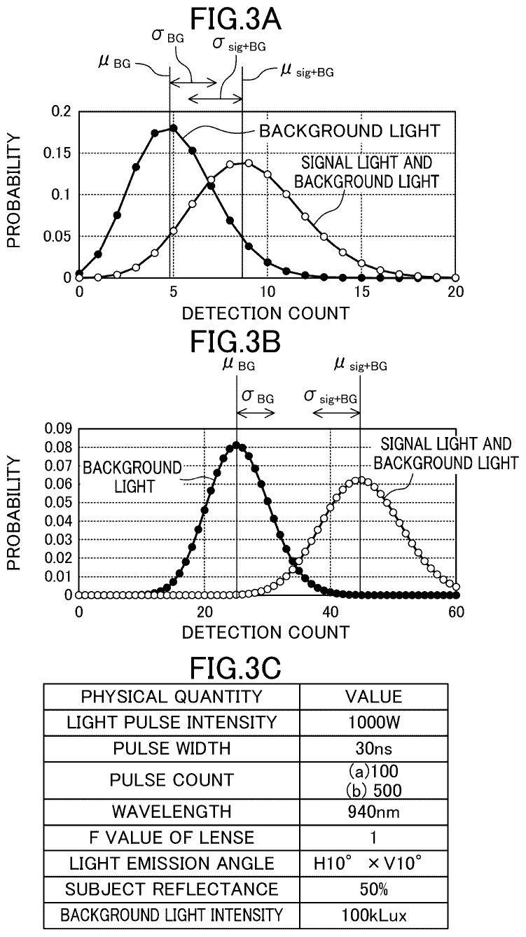

FIG. 3 shows exemplary simulation results. FIGS. 3A and 3B are graphs showing distribution of the detection probability, where the horizontal axis indicates the detection counts and the vertical axis indicates the probability. Black circles show distribution of the background light alone, and white circles show distribution of the signal light and the background light together. The prerequisites of the simulation are as shown in FIG. 3C. An assumed light source is a light diffusion source. The pulse count is 100 in FIG. 3A and 500 in FIG. 3B.

FIG. 3A shows an example where it is difficult to distinguish the background light and the signal light. That is, distribution of the background light alone and distribution of the signal light and the background light together overlap with each other to a large extent, and thus the possibility of erroneous determination is high. On the other hand, FIG. 3B shows an example where it is possible to distinguish the background light and the signal light. That is, distribution of the background light alone and distribution of the signal light and the background light together are separated so that the ranges of their standard deviations do not overlap with each other (p_{sig+BG}−σ_{sig+BG}>μ_{BG}+σ_{BG}). In this case, the possibility of erroneous determination is low.

By the simulation of FIG. 3 being conducted with various conditions of the pulse count, the total light intensity of light emitted where the background light and the signal light can be separated can be calculated.

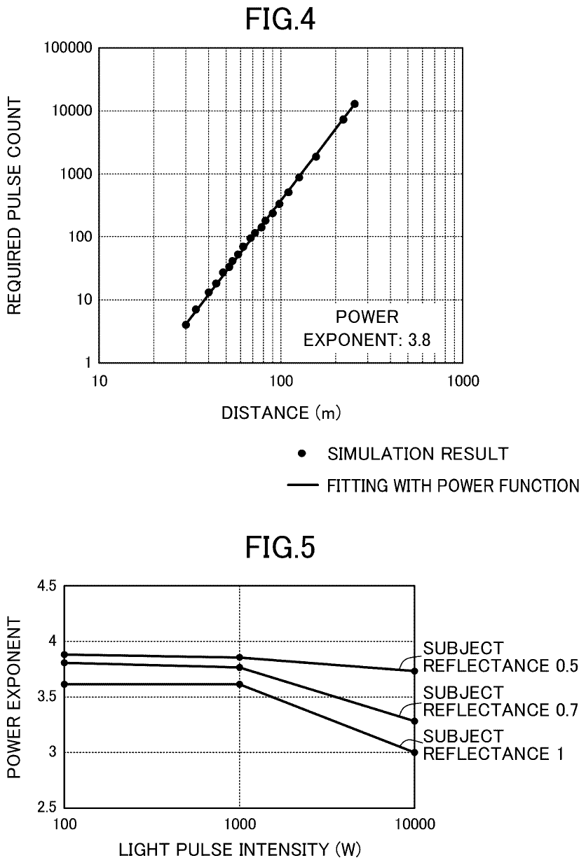

FIG. 4 shows a simulation result where the required pulse count was calculated for each distance. In FIG. 4, the minimum pulse count (the required pulse count) was calculated while the light pulse intensity and the light pulse width were fixed and with the pulse count was varied. In FIG. 4, each circle indicates a simulation result, and solid lines constitute a fitting curve of the power function. As shown in FIG. 4, the required pulse count varies with the distance raised to the power of 3.8 in this simulation.

FIG. 5 shows simulation results where the power exponents were calculated while the light pulse intensity and the subject reflectance were varied. The lines in FIG. 5 show power exponents calculated with variation of subject reflectance of 0.5, 0.7, and 1. As shown in FIG. 5, as the subject reflectance is higher, the power exponent is lower, and as the subject reflectance is lower, the power exponent is higher. Here, as the light pulse intensity is higher, the difference in intensity between the signal light and the background light is smaller. Thus, the condition of the expression (14) is not satisfied, and the exponents of the power functions are lowered as shown in FIG. 5. On the other hand, although in terms of eye safety and the like, the upper limit of the light pulse intensity is about 10,000 W, the power exponent does not fall below 3 even when the light pulse intensity is 10,000 W and the subject reflectance is 1 which makes the power exponent minimum as shown in FIG. 5. Thus, from the simulation results, the power exponent is desirably greater than 3 and less than or equal to 4. Although, in FIG. 5, the upper limit of the light pulse intensity is 10,000 W, the upper limit may be a higher value if the light emission angle is increased.

The present embodiment assumes detection of weak signal light, and thus the light receiver desirably has high sensitivity. The light receiver may be, for example, a photomultiplier tube or may be a photon counter such as a single photon avalanche diode (SPAD). The light receiver 102 may include photodetectors arranged in an array or may be an imaging device including a lens or the like. The light emitter 101 may be a laser having a single wavelength, and its wavelength band may be set to infrared light. The light receiver 102 may include a band-pass filter according to the wavelength of the light emitter 101.

### <Modification of Distance Measurement Sequence>

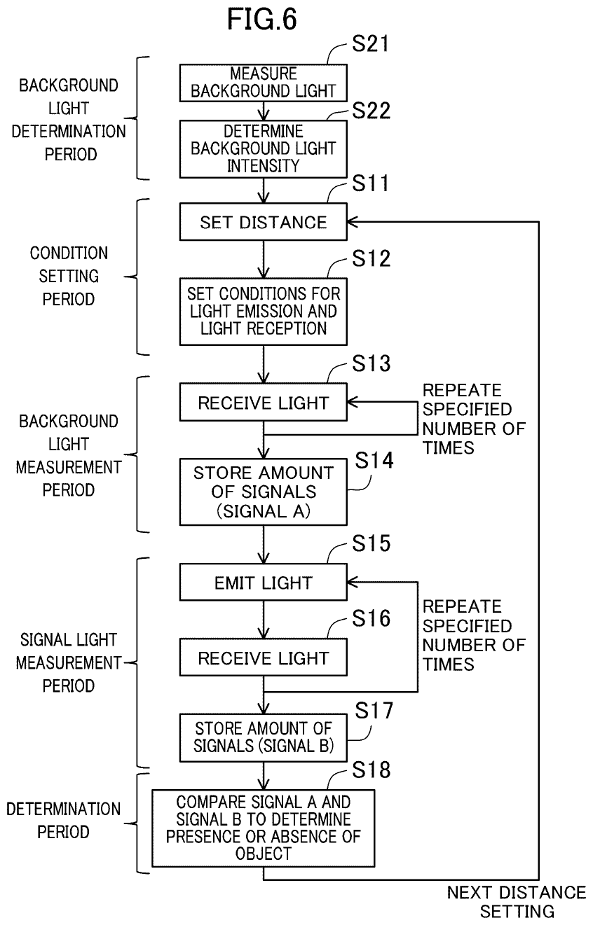

FIG. 6 shows a modification of the distance measurement sequence. The sequence of FIG. 6 has a background light determination period provided at the beginning of the sequence of FIG. 2. In this case, the distance measurement system 10 has a function of detecting the intensity of the background light. In general, it is known that when the total light intensity of the signal light is extremely higher than that of the background light, the probability that the signal light is detected is in inverse proportion to the square of the distance. Thus, the exponent of the power function where the total light intensity of light emitted is changed with respect to the distance is preferably changed according to the background light intensity.

Specifically, the background light is measured in the background light determination period (S21). Then, it is determined whether the measured background light intensity is higher than a certain determination criterion (S22). If the background light intensity is higher than a certain determination criterion, the exponent of the power function where the total light intensity of light emitted is changed with respect to the distance is set to a first value when the light emission condition is set (S12), where the first value is greater than 3 and less than or equal to 4. On the other hand, if the background light intensity is lower than a certain determination criterion, the exponent of the power function where the total light intensity of light emitted is changed with respect to the distance is set to a value when the light emission condition is set (S12), where the value is greater than 2 and less than or equal to the first value.

In the background light determination period, the background light may be measured by the light receiver 102, or may be done by a photodetector provided separately from the light receiver 102. If the light receiver 102 is used, a measurement result of the background light in the background light determination period may be used as a signal A.

### <Exemplary Configuration of Photodetector Used for Light Receiver>

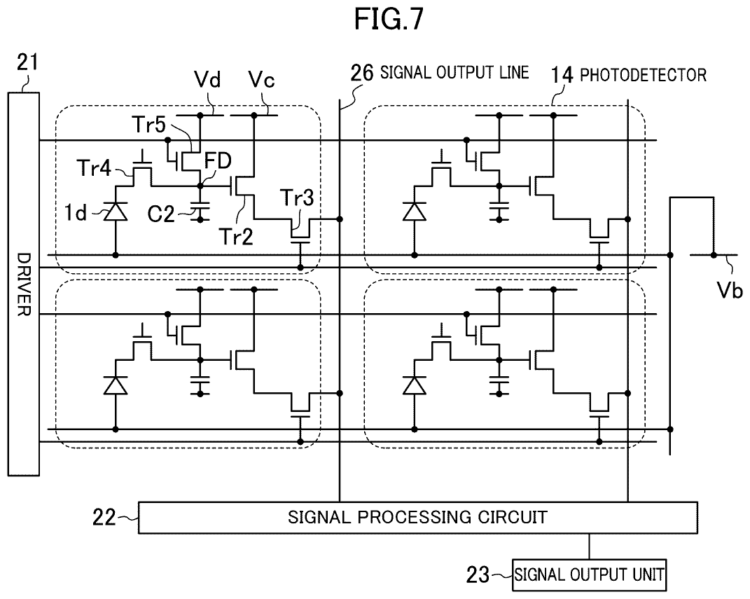

FIG. 7 shows an exemplary circuit configuration of a photodetector used for the light receiver 102. FIG. 7 shows a configuration where a plurality of photodetectors 14 are arranged in an array. In FIG. 7, the number of photodetectors 14 is two by two, but any number of photodetectors 14 may be arranged. Each photodetector 14 includes a photodiode 1d, transistors Tr2, Tr3, Tr4, and Tr5, and a capacitor C2. The configuration of FIG. 7 also includes a driver 21, a signal processing circuit 22, and a signal output unit 23.

One end of the transistor Tr2 is connected to a power supply Vc, the other end of the transistor Tr2 is connected to one end of the transistor Tr3, and a gate of the transistor Tr2 is connected to a floating diffusion FD (which may be hereinafter referred to as “FD”). A gate of the transistor Tr3 receives a selection signal, and the other end of the transistor Tr3 is connected to a signal outputting line 26. One end of the transistor Tr4 (transfer transistor) is connected to a cathode of the photodiode 1d, a gate of the transistor Tr4 receives a transfer signal, and the other end of the transistor Tr4 is connected to the FD. The transistor Tr4 transfers a signal charge supplied from the photodiode 1d to the FD according to the transfer signal. One end of the transistor Tr5 (reset transistor) is connected to a power supply Vd, the other end of the transistor Tr5 is connected to the FD, and a gate of the transistor Tr5 receives a reset signal. One end of the capacitor C2 is connected to the FD, and the other end of the capacitor C2 is connected to a grounded power supply.

The driver 21 sends a reset signal to the gate of the transistor Tr5 of each photodetector 14 in order to drive the transistor Tl. The driver 21 sends a selection signal to the gate of the transistor Tr3 of each photodetector 14 in order to drive the transistor Tr3. The signal processing circuit 22 is connected with the signal outputting line 26; receives an output signal supplied from each photodetector 14; makes certain processing on the output signal; and outputs a signal to the signal output unit 23. The signal output unit 23 is, for example, a PC, a display, or the like, and outputs numerical data or image data based on a signal received from the signal processing circuit 22.

Here, the photodiode 1d of the photodetector 14 may be an avalanche photodiode or may be a single photon avalanche diode. In this case, the voltage of the power supply Vb may be lowered (i.e., the absolute voltage is increased) so that a reverse bias enabling avalanche multiplication can be applied to the photodiode 1d.

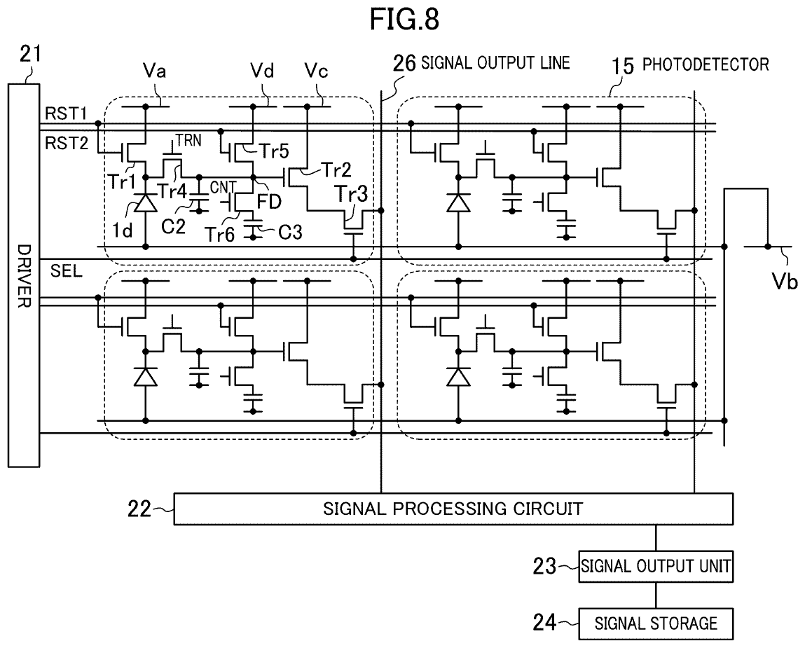

FIG. 8 shows another exemplary circuit configuration of a photodetector used for the light receiver 102. FIG. 8 shows a circuit configuration where in addition to the configuration of the photodetector 14 of FIG. 7, each photodetector 15 includes transistors Tr1 and Tr6 and a capacitor C3. The driver 21 sends a reset signal RST1 to the gate of the transistor Tr1; sends a reset signal RST2 to the gate of the transistor Tr5; and sends a selection signal SEL to the gate of the transistor Tr3.

One end of the transistor Tr1 (reset transistor) is connected to a power supply Va, the other end of the transistor Tr1 is connected to the cathode of the photodiode 1d, and a gate of the transistor Tr1 receives the reset signal RST1. One end of the transistor Tr6 is connected to the FD, a gate of the transistor Tr6 receives a count signal CNT, and the other end of the transistor Tr6 is connected to one end of the capacitor C3. The other end of the capacitor C3 is connected to a grounded power supply. According to the count signal CNT, the transistor Tr6 (count transistor) allows the capacitor C3 to accumulate signal charges transferred to the FD. The capacity of the capacitor C3 may be larger than that of the capacitor C2.

Here, in the circuit configurations of FIG. 7 and FIG. 8, the transistors Tr1 to Tr6 have N-type channels, but may have P-type channels.

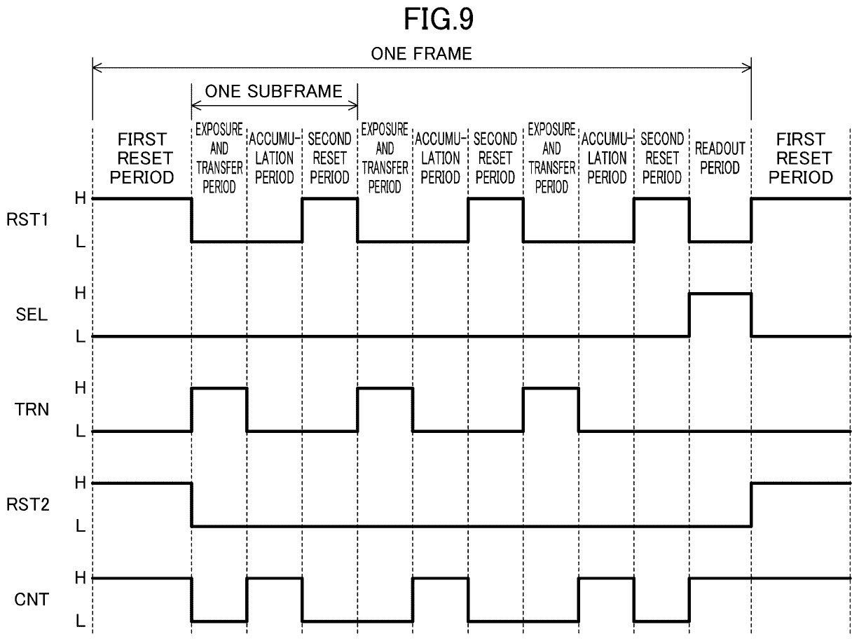

FIG. 9 is a timing chart of operation of the photodetector 15 of FIG. 8. In FIG. 9, one frame includes a first reset period, a plurality of subframes (three subframes in FIG. 9), and a readout period. The subframe includes an exposure and transfer period, an accumulation period, and a second reset period. The photodetector 15 repeatedly executes the operation defined in one frame. One frame may include two or more subframes.

In the first reset period, the reset signal RST1 is at a high level, the selection signal SEL is at a low level, the transfer signal TRN is at a low level, the reset signal RST2 is at a low level, and the count signal CNT is at a high level. Thus, the transistor Tr1 is turned on, the transistor Tr3 is turned off, the transistor Tr4 is turned off, the transistor Tr5 is turned on, and the transistor Tr6 is turned on. Accordingly, in the reset period, the photodiode 1d is reset to the voltage value of the power supply Va, and the voltage values of the FD and the capacitor C3 are reset to the voltage value of the power supply Vb. In the reset period, the photodiode 1d, the FD, and the capacitor C3 are reset at the same time, but individual periods for resetting the photodiode 1d, the FD, and the capacitor C3 may be provided in the reset period.

In the exposure and transfer period, the reset signal RST1 is at a low level, the selection signal SEL is at a low level, the transfer signal TRN is at a high level, the reset signal RST2 is at a low level, and the count signal CNT is at a low level. Thus, the transistor Tr1 is turned off, the transistor Tr3 is turned off, the transistor Tr4 is turned on, the transistor Tr5 is turned off, and the transistor Tr6 is turned off. Accordingly, in the exposure and transfer period, if receiving incident light, the photodiode 1d generates (exposes) a signal charge through avalanche multiplication, and thus the cathode voltage of the photodiode 1d changes. Further, the signal charge generated by the photodiode 1d is transferred to the capacitor C2 via the transistor Tr4 and the FD, and thus the voltage value of the capacitor C2 changes. In the exposure and transfer period, the exposure of the photodiode 1d and the transfer of the signal charges to the FD are done at the same time. Alternatively, in the exposure and transfer period, the exposure period of the photodiode 1d and the transfer period of the signal charges may be provided individually.

In the accumulation period, the reset signal RST1 is at a low level, the selection signal SEL is at a low level, the transfer signal TRN is at a low level, the reset signal RST2 is at a low level, and the count signal CNT is at a high level. Thus, the transistor Tr1 is turned off, the transistor Tr3 is turned off, the transistor Tr4 is turned off, the transistor Tr5 is turned off, and the transistor Tr6 is turned on. Accordingly, in the accumulation period, the signal charges accumulated in the capacitor C2 are transferred to the capacitor C3 via the FD and transistor Tr6 and accumulated in the capacitor C3.

In the second reset period, the reset signal RST1 is at a high level, the selection signal SEL is at a low level, the transfer signal TRN is at a low level, the reset signal RST2 is at a low level, and the count signal CNT is at a low level. Thus, the transistor Tr1 is turned on, the transistor Tr3 is turned off, the transistor Tr4 is turned off, the transistor Tr5 is turned off, and the transistor Tr6 is turned off. Accordingly, in the second reset period, the photodiode 1d is reset to the voltage value of the power supply Va, and thus the photodiode 1d can be exposed to light in the subsequent exposure period. In the second reset period, the count signal CNT may be at a low level and the transistor Tr6 may be turned on.

In the readout period, the reset signal RST1 is at a low level, the selection signal SEL is at a high level, the transfer signal TRN is at a low level, the reset signal RST2 is at a low level, and the count signal CNT is at a high level. Thus, the transistor Tr1 is turned off, the transistor Tr3 is turned on, the transistor Tr4 is turned off, the transistor Tr5 is turned off, and the transistor Tr6 is turned on. Accordingly, in the readout period, the signal charges accumulated in the capacitor C3 are output (read out) to the signal processing circuit 22 via the signal outputting line 26.

Here, the photodetector 15 of FIG. 8 includes a capacitor C3 as a first memory provided inside the photodetector 15 and configured to record a detection count. The capacitor C3 is capable of accumulating signal charges generated, and the number of accumulated signal charges increases according to the number of light detections by the photodiode 1d. Thus, the capacitor C3 can store light detection counts.

The signal storage 24 is, for example, a memory as a second memory, and is capable of storing signals supplied from the signal output unit 23 and capable of storing light detection counts. Here, since the capacitor C3 is provided in the photodetector 15, the area of the capacitor C3 is limited and the capacity of the capacitor C3 is small. Thus, the upper limit of the detection count that can be recorded is small, and a necessary detection count may be unable to be recorded. In contrast, by the signal storage 24 being provided outside the photodetector 15, the area of the capacitor can be increased, and the detection count that can be recorded can be increased.

In particular, if the background light is strong, the signal storage 24 is preferably used because a detection count required for a distant place becomes high. If the background light is weak, the capacitor C3 as the first memory may be used, and if the background light is strong, the signal storage 24 as the second memory may be used.

A process of addition of detection counts of a plurality of photodetectors 15 may be conducted. Accordingly, the detection count can be increased.

The circuit configuration of the photodetector is not limited to those of FIG. 7 and FIG. 8. For example, the first memory may consist of a plurality of capacitors. The capacitor may be a metal-insulator-metal (MIM) capacitor, or may be another type of memory element.

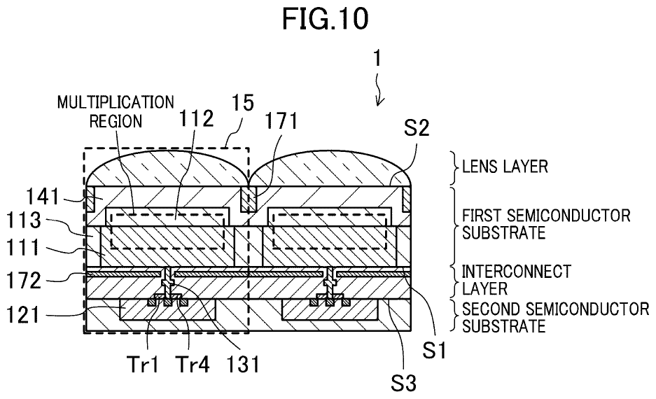

FIG. 10 is a sectional view of an exemplary device configuration of the photodetector of FIG. 8. In FIG. 10, a semiconductor chip 1 includes a first semiconductor substrate, a second semiconductor substrate, a lens layer, and an interconnect layer, and the semiconductor chip 1 consists of a plurality of photodetectors 15.

Specifically, the lens layer is formed on a second principal surface S2 of the first semiconductor substrate. The interconnect layer is formed between a first principal surface S1 of the first semiconductor substrate and a third principal surface S3 of the second semiconductor substrate.

The first semiconductor substrate includes first to fourth semiconductor layers 111 to 114 that constitute the photodiode 1d. A trench 171 extending in the top-to-bottom direction in the drawing is formed between the second semiconductor layers 112 adjacent to each other. Although not shown, the trench 171 is formed in a lattice pattern in plan view to separate the second semiconductor layers 112 of the photodetector 15 from one another. The trench 171 made of a material that reflects incident light can reduce crosstalk between the photodetectors 15 adjacent to each other.

A first well 121 and the transistors Tr1 and Tr4 are formed on the second semiconductor substrate. The transistors Tr1 and Tr4 are connected to the first semiconductor layer 111 via a first interconnect 131 formed in the interconnect layer. Although not shown, the transistors in FIG. 8 are formed on the second semiconductor substrate.

A reflector 172 is formed in the interconnect layer. The reflector 172 is made of a material that reflects incident light. Accordingly, the incident light that is incident on the photodetector 15 is more easily incident on the photodiode 1d.

In FIG. 10, the photodiode 1d is formed on the first semiconductor substrate, and a circuit including transistors and wiring is configured on the second semiconductor substrate and the interconnect layer. Accordingly, the photodiode 1d and the circuit section can be fabricated separately. Transistors, wiring, and the like are formed on another substrate (the second semiconductor substrate), and thus the aperture ratio of the photodiode 1d can be increased and the light efficiency can be improved.

By the photodiode 1d being formed on the first semiconductor substrate and the circuit being formed on the second semiconductor substrate, the area and the capacity of the first memory can be increased. Accordingly, the upper limit of the detection count can be increased.

As the first memory, a random access memory (RAM) may be provided in each photodetector. Three or more semiconductor layers rather than two semiconductor layers may be provided. Accordingly, the capacity of the first memory can be increased and the upper limit of the detection count can be increased.

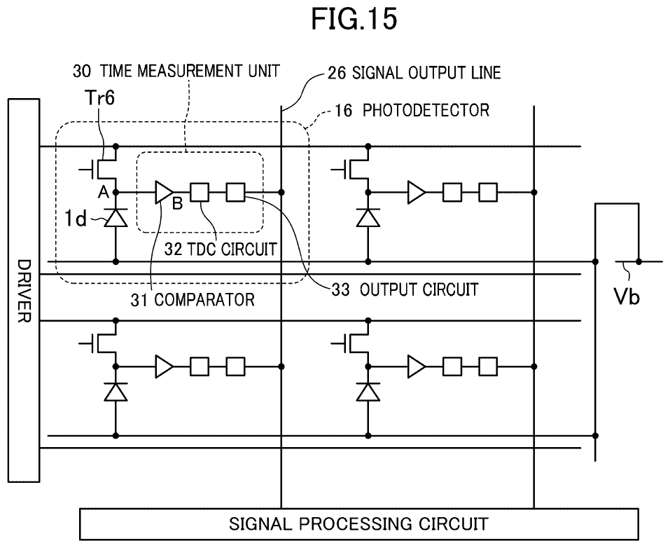

FIG. 15 shows another exemplary circuit configuration of a photodetector used for the light receiver 102. The photodetector 16 includes a photodiode 1d, a transistor Tr6, and a time measurement unit 30. The time measurement unit 30 includes a comparator 31, a time-to-digital converter (TDC) circuit 32, and an output circuit 33. Although not shown, a controller for controlling the TDC circuit 32 may be provided to determine whether to operate the TDC circuit.

The transistor Tr6 functions as a quenching resistor to quench avalanche multiplication in the photodiode 1d. After quenching is completed, the voltage of the photodiode 1d is recharged. The transistor Tr6 only has to have a quenching function and a recharging function, and may be replaced with a resistor or a coil. In FIG. 15, the channel polarity of the transistor Tr6 is N-type but may be P-type.

The time measurement unit 30 records and outputs the time at which the signal from the photodiode 1d is detected. Upon receiving a signal exceeding a preset threshold, the comparator 31 changes the output in this period only. The TDC circuit 32 outputs to the output circuit 33 the time at which the output of the comparator 31 is changed. The output circuit 33 has a memory to record the output from the TDC circuit 32, and performs a necessary calculation and outputs an operation result.

Although, in FIG. 15, the output circuit 33 is provided in each photodetector 16, the output circuit 33 may be shared among the plurality of photodetectors 16, or the output circuit 33 may be partially or entirely integrated with the signal processing circuit. Here, the comparator 31 is, for example, an inverter, and the memory is, for example, a dynamic random access memory (DRAM). The TDC circuit 32 in FIG. 15 may be replaced with another circuit configuration having a function of converting time into a signal. For example, a time-to-analog converter circuit may be used.

In FIG. 15, the time measurement unit 30 is connected to the cathode of the photodiode 1d but may be connected to the anode thereof. The signal from the photodiode 1d is, for example, a voltage change at the cathode of the photodiode 1d.

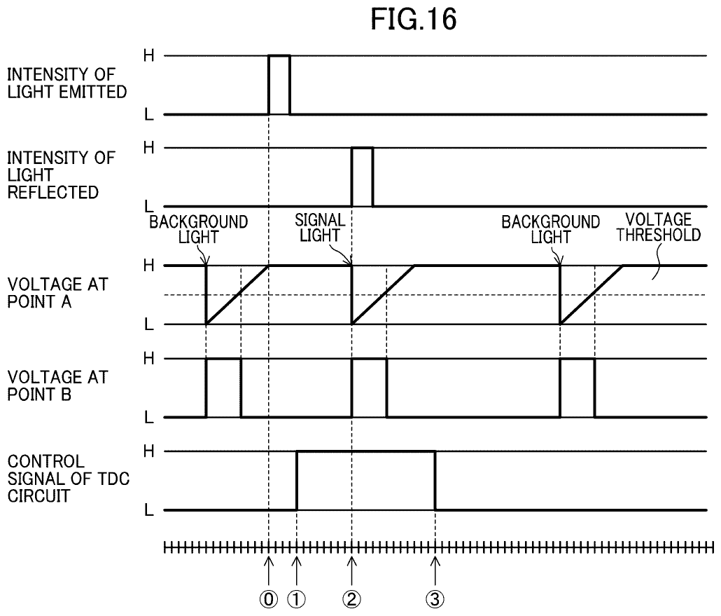

FIG. 16 shows exemplary signal changes in a time measurement operation of the circuit of FIG. 15. Here, the time measurement operation refers to an operation of the time measurement unit 30 recording the time at which the output of the photodiode 1d (e.g., a voltage change at the cathode) is changed. FIG. 16 has the horizontal axis representing the time, and shows the intensity of light emitted; the intensity of light reflected that is reached when the light emitted is reflected by the subject and then reaches the light receiver; the voltage at a point A in FIG. 15; the voltage at a point B in FIG. 15; and the control signal to control the TDC circuit 32 in FIG. 15. At the lowermost of FIG. 16, a lateral line ticked according to the clock cycle is provided. The time indicated by arrows includes: (0) the time at which light is emitted; (1) the time at which the TDC circuit 32 starts operation; (2) the time at which the light reflected is detected; and (3) the time at which the TDC circuit 32 ends operation.

In FIG. 16, the “H” means that the light intensity is high or that the voltage is high, and the “L” means that the light intensity is low or that the voltage is low. Note that the “H” and “L” may be different from those in FIG. 16 depending on the circuit configuration or the channel polarity of the transistors. Further, an environment where the background light is present is assumed, and on the axis representing the voltage at the point A, the timings at which the background light or the signal light is detected are indicated by arrows.

If light is detected, the voltage of the photodiode 1d changes sharply from H to L due to avalanche multiplication and quenching. The lateral broken line shows the voltage threshold of the comparator 31, and if the voltage at the point A falls below the voltage threshold, the voltage at the point B that is an output of the comparator 31 changes from L to H. After turning to L, the voltage at the point A is recharged from L to H with a certain time constant. In this time, if the voltage at the point A exceeds the voltage threshold, the voltage at the point B changes from H to L.

The TDC circuit 32 operates only while the control signal of the TDC circuit 32 is H, and the period from the time (1) to the time (3) is regarded as an operation period. Only after the control signal turns to H, the TDC circuit 32 outputs the time taken before the output of the comparator 31 (i.e., the voltage at the point B) turns to H. In FIG. 16, the time τ02 from the time (1) to the time (2) is output. The time τ01 from the time (0) to the time (1) is set in advance, and the distance to an object is calculated by

$$c * ( τ01 + τ 02 ) / 2 ( c \text{:} the speed of light ) .$$

The time (3) is set so that the time τ03 from the time (0) to the time (3) matches the maximum distance c*τ03/2 that is to be measured. In FIG. 16, the time (0) and the time (1) are different, which avoids influence of light reflected from an object located at a distance of less than c*τ01/2. Note that the time (0) and the time (1) may be the same.

In this case, desirably, the product of the intensity, the pulse width, and the pulse count of the pulsed light emitted is changed according to the power function where the distance to be measured is a variable, such that the power exponent of the power function is set greater than 3 and less than or equal to 4. In particular, since the maximum distance to be measured is in proportion to the time τ03 from the time (0) to the time (3), the product of the intensity, the pulse width, and the pulse count of the pulsed light emitted may be changed according to the power function where τ03 is a variable, such that the power exponent of the power function is set greater than 3 and less than or equal to 4.

Although, in FIG. 16, the emission count of pulsed light (the pulse count) is one, the pulse count may be increased by, for example, repeating the operation of FIG. 16 several times. In the present embodiment, the time of light detection can be recorded as digital values, and the distance resolution may be improved.

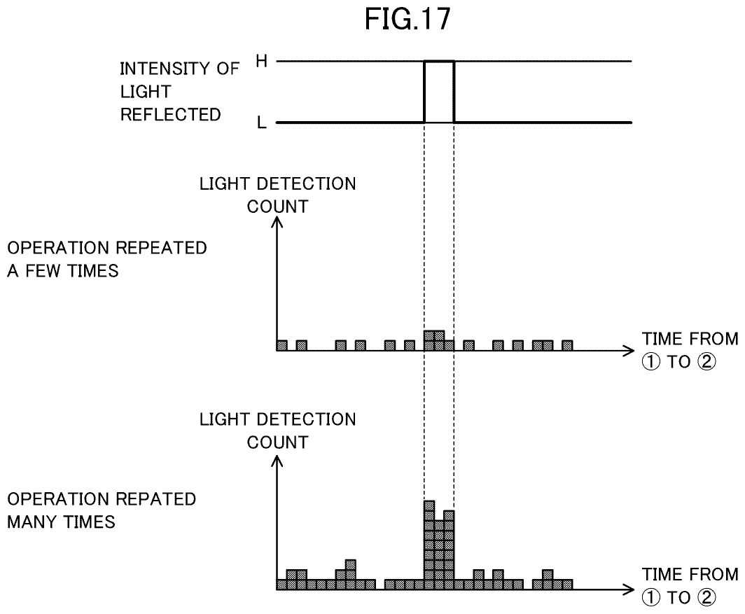

FIG. 17 shows exemplary operation of the output circuit, which is histogram processing where the operation of FIG. 16 is conducted several times and where the time from the time (1) to the time (2) is recorded several times. In FIG. 16, one light pulse is produced per operation, and thus how many times the operation of FIG. 16 is repeated (repetition count) is equal to the light pulse count. In FIG. 17, the first graph shows the intensity of light reflected, the second graph shows an exemplary histogram where the operation of FIG. 16 is repeated a few times, and the third graph shows an exemplary histogram where the operation of FIG. 16 is repeated many times.

The range of the horizontal axes shows the range in which the control signal of the TDC circuit 31 is H. The origin of the horizontal axis corresponds to the time (1) of FIG. 16. Here, the horizontal axis may be offset by τ01 so that the time (0) is presented as the origin of the horizontal axis. How the horizontal axis is arranged is not limited.

Here, it is assumed that in an environment where the background light is present, the reflected light is detected not always but with a certain probability, and it is assumed that both signals by the background light and signals by the reflected light contribute to the histogram. The light detection count produced when the intensity of light reflected is L is equal to the light detection count produced by the background light alone. The light detection count produced when the intensity of light reflected is H is equal to the light detection count produced by the sum of intensities of the background light and the reflected light. If the repetition count is low, the light detection count is low, and it is difficult to distinguish the light detection by the light reflected and the signal light derived from the background light. As the repetition count increases, the light detection count increases, and thus the difference between the light detection count produced when the intensity of light reflected is L and the light detection count produced when the intensity of light reflected is H becomes clear. Accordingly, the time at which the light reflected returns can be more accurately measured.

When the intensity and pulse width of the light emitted are constant, the repetition count may be changed according to the power function where the period from the time (0) to the time (3) is a variable, such that the power exponent of the power function is set greater than 3 and less than or equal to 4. Accordingly, the most efficient distance measurement can be performed, and the time for the distance measurement can be shortened. The above distance measurement system of the present disclosure may be a system adopting a so-called sub-range method. Specifically, for example, the distance measurement system of the present disclosure divides a space to be imaged, i.e., an imaging region into a plurality of distance zones (referred to as “sections”) based on the distances from a reference point in the depth direction, and then generates section images for those distance zones based on the amount of the light reflected out of the light emitted. Then, based on those plurality of section images (referred to as “a set of section images”), a distance image is generated.

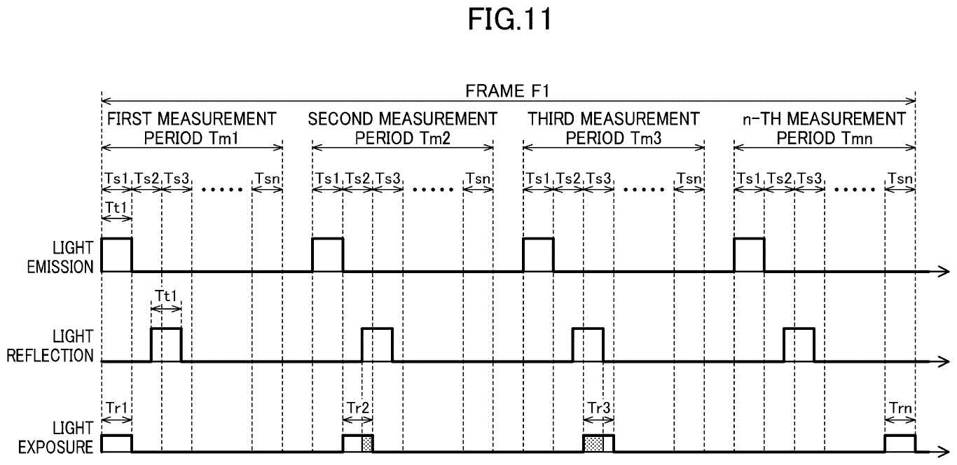

FIG. 11 shows an exemplary set of timings of light emission, light reflection, and light exposure according to a sub-range method. F1 denotes a time for one frame; Tt1 denotes a pulse width of light emitted; Ts1, Ts2, Ts3, . . . , Tsn denote time widths of sections corresponding to the distance sections 1, 2, 3, . . . , n; Tm1, Tm2, Tm3, . . . , Tmn denote time widths of measurement periods; and Tr1, Tr2, Tr3, . . . , Trn are time widths of light exposure. In FIG. 11, the widths Tt1, Ts1 to Tsn, and Tr1 to Trn are the same, but may not necessarily be the same. The widths Tt1, Ts1 to Tsn, and Tr1 to Trn may be changed as appropriate for each measurement period. In FIG. 11, light emission is done only once in each measurement period, but light emission may be repeated several times.

In this case, the product of the light intensity, the pulse width, and the pulse count is preferably changed by the power function of the distance according to the distance corresponding to the section, and in an environment where the background light is present, the power exponent is preferably greater than 3 and less than or equal to 4. For example, when the light intensity and the pulse width are constant, the pulse count, i.e., the repetition count of light emitted may be changed based on the power function of the distance according to the distance corresponding to the section so that the power exponent is set greater than 3 and less than or equal to 4.

In the i-th measurement period (i=1, 2, 3, . . . , n), presence or absence of a subject in the distance section i is determined. According to the distance to the subject, the reflected light returns with a certain time delay with respect to the light emission. In the example of FIG. 11, the reflected light returns across the sections 2 and 3. When the time in which the reflected light returns overlaps the time in which light exposure is done, a signal of light intensity according to the time of overlapping is detected. When the time in which the reflected light returns does not overlap the time in which light exposure is done, a signal according to the background light is detected.

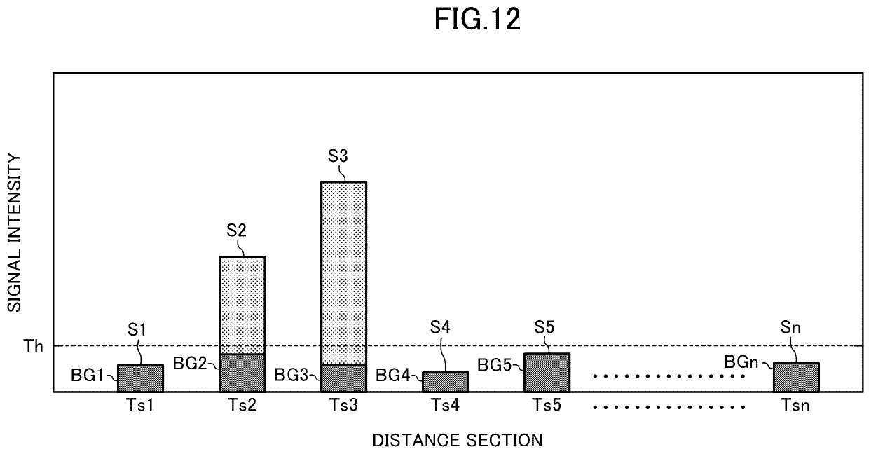

FIG. 12 shows an exemplary simulation of signal intensity in each distance section shown in FIG. 11. The dark hatching corresponds to the signal intensity derived from the background light, and the light hatching corresponds to the signal intensity derived from light emission. This exemplary simulation shows an example where the signal light returns across the sections 2 and 3 as shown in FIG. 11. In this case, in the sections other than sections 2 and 3, the signal intensity of the background light is obtained, and in the sections 2 and 3, the signal intensity of signal light by light emission is obtained.

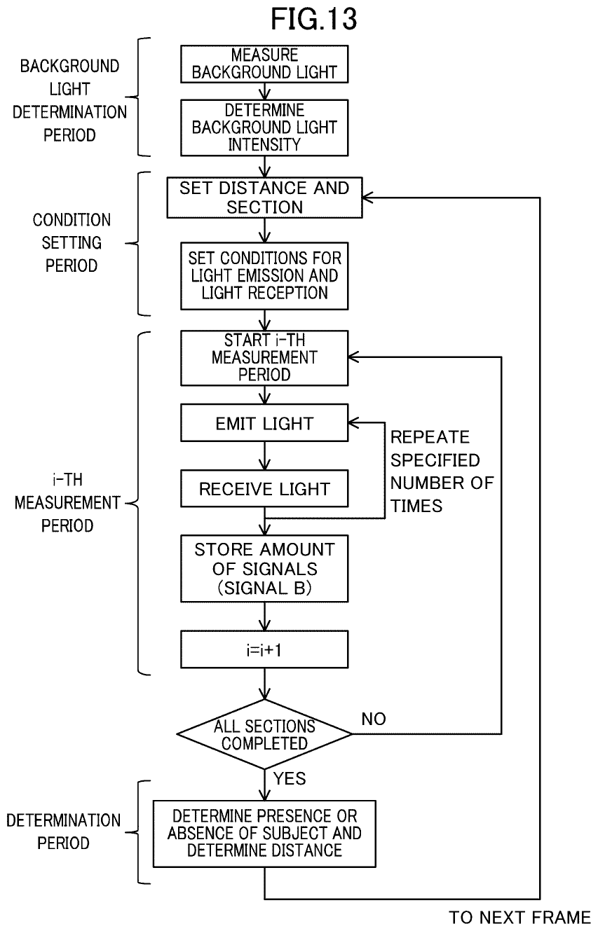

FIG. 13 shows an exemplary distance measurement sequence according to the sub-range method. In comparison to the sequence of FIG. 6, the sequence of FIG. 13 contains the condition setting period where a section as well as a distance is set; contains no background light measurement period; and contains an i-th measurement period instead of the signal light measurement period, where operation is repeated n times. In the determination period, both presence or absence of a subject and a distance to the subject are determined. According to the sub-range method, the signal intensity in the section where the reflected light does not return can be used as the signal intensity of the background light, and thus the background light measurement period is not required.

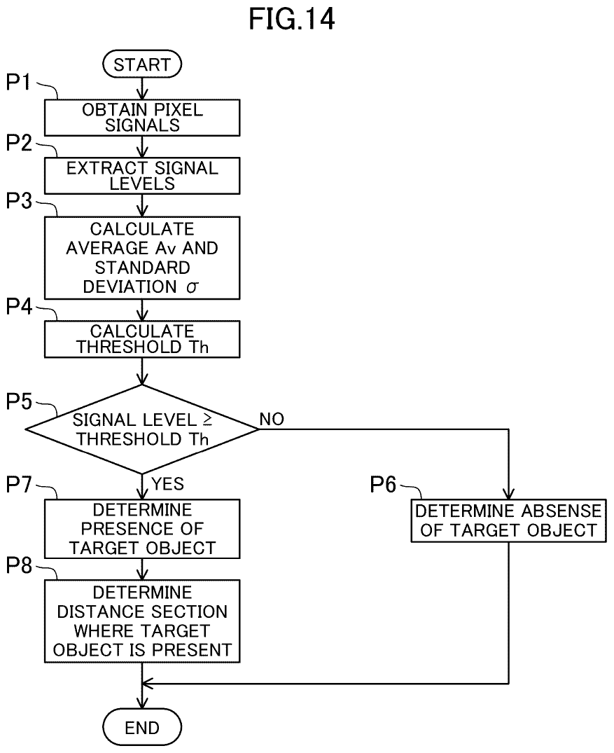

FIG. 14 shows an exemplary algorithm for determining presence or absence of a subject and a distance to the subject in a determination period. The distance calculator 105 obtains a plurality of pixel signals corresponding to the plurality of divided periods Ts from the light receiver 102 (P1). The distance calculator 105 includes a section determination unit and a section distance calculator. The section determination unit extracts signal levels of the pixel signals in the plurality of divided periods Ts in one frame F1 (P2). The section determination unit calculates an average Av and a standard deviation σ of the signal levels, except the highest and second highest signal levels, of the pixel signals in the plurality of divided periods Ts (P3). The section determination unit calculates a threshold Th using the average Av and the standard deviation α (P4).

The section determination unit compares the signal level of the pixel signal in each divided period Ts with the threshold Th (P5). If the signal level of the pixel signal in the divided period Ts is less than the threshold Th (P5: No), the section determination unit determines that a target object is absent in the measurable distance (P6). If the signal level of the pixel signal in the divided period Ts is higher than or equal to the threshold Th (P5: Yes), the section determination unit determines that a target object is present in the measurable distance (P7). The section determination unit determines a distance section where the target object is present among the plurality of distance sections (P8). Here, it is assumed that the target object is present across two distance sections (a first distance section and a second distance section).

As described above, according to the sub-range method, the signal intensity of the background light can be calculated in P3 of FIG. 14. By using the calculated signal intensity of the background light, the intensity of the background light can be calculated, and the conditions for light emission and light reception in each distance section can be set.

Here, as described above, in a section corresponding to a distant place, repetition counts of light emission and light exposure are increased in some cases, where the signal intensity of the background light increases according to the repetition counts of light emission and light exposure. In such cases, it is preferable to standardize the detected signal intensities according to the count of light emission and the count of light exposure. Specifically, in P4 of FIG. 14, values obtained by dividing the signal intensities by the count of light emission and the count of light exposure may be used to calculate the average Av and the standard deviation

According to the sub-range method, light exposure is done in a predetermined section only, and thus the background light can be less detected. Accordingly, distance measurement can be performed while being less influenced by the background light, and thus farther distances can be measured.

### INDUSTRIAL APPLICABILITY

The distance measurement system of the present disclosure enables appropriate setting of the intensity of pulsed light depending on a distance to be measured, and thus is useful, for example, for more accurate distance measurement.

### DESCRIPTION OF REFERENCE CHARACTERS

1d Photodiode
10 Distance Measurement System
14, 15 Photodetector
24 Signal Storage (Second Memory)
60 Measurement Target
101 Light Emitter
102 Light Receiver
103 Controller
105 Distance Calculator
AA Pulsed Light
BB Reflected Light
C3 Capacitor (First Memory)
FD Floating Diffusion
Tr1 to Tr6 Transistor

1. A distance measurement system used in an environment where background light is present, comprising:
a light emitter configured to emit pulsed light;
a light receiver configured to receive the pulsed light reflected by a target object;
a controller configured to control operation of the light emitter and the light receiver; and
a distance calculator configured to calculate a distance to the target object based on a time taken before the pulsed light returns to the light receiver,
wherein
the controller changes a product of an intensity, a pulse width, and a pulse count of the pulsed light according to a power function where a distance to be measured is a variable, such that a power exponent of the power function is set to a first value greater than 3 and less than or equal to 4.

2. The distance measurement system of claim 1, wherein
the distance measurement system has a function of detecting an intensity of background light, and
the controller sets the power exponent of the power function to a value greater than 2 and less than or equal to the first value if the intensity of the background light detected falls below a predetermined reference.

3. The distance measurement system of claim 1, wherein
the light receiver includes a plurality of photodetectors arranged in an array, and
the light emitter emits diffused light as the pulsed light.

4. The distance measurement system of claim 3, wherein
the photodetector includes a photon counter or a single photon avalanche diode (SPAD).

5. The distance measurement system of claim 3, wherein
each of the photodetectors includes a first memory provided inside the photodetector and configured to record a light detection count, and
the light receiver includes a second memory provided outside the photodetector and configured to record a light detection count.

6. The distance measurement system of claim 5, wherein
when the background light is measured, the second memory is used if the intensity of the background light is high, and the first memory is used if the intensity of the background light is low.

7. The distance measurement system of claim 5, wherein
the first memory is a metal-insulator-metal capacitor (MIM).

8. The distance measurement system of claim 3, wherein
the photodetector includes a photodiode, a reset transistor, a floating diffusion, a transfer transistor, and a count transistor.

9. The distance measurement system of claim 1, wherein
the distance measurement system divides an imaging region into a plurality of sections based on distances; generates a section image for each of the plurality of sections; and generates a distance image based on the plurality of section images.
